(19) United States
(12) Patent Application Publication
(10) Pub. No.: US 2007/0128414 A1
(43) Pub. Date: Jun. 7, 2007

(54) Dewatering and thickening belt and manufacturing method thereof

(75) Inventor: Tatsutoshi Nakajima, Shizuoka (JP)

Correspondence Address: RADER FISHMAN & GRAUER PLLC, LION BUILDING, 1233 20TH STREET N.W., SUITE 501, WASHINGTON, DC, 20036, US

(73) Assignee: NIPPON FILCON CO., LTD., Tokyo (JP)

(21) Appl. No.: 11/634,940

(22) Filed: Dec. 7, 2006

(30) Foreign Application Priority Data
Dec. 7, 2005 (JP) 2005-353401

(51) Int. Cl. B32B 5/02; B32B 23/02; B32B 27/04

(52) U.S. Cl. 428/194; 442/203; 442/205; 442/104; 428/192; 428/193

(57) ABSTRACT

A dewatering and thickening belt having an endless fabric woven by a synthetic resin filament, a bending-resistant element and a guide protrusion, wherein the fabric is a two-layer fabric obtained by binding an upper surface layer composed of upper surface side warps and upper surface side wefts and a lower side layer composed of lower surface side warps and lower surface side wefts with warp binding yarns for weaving the upper and lower layers. The bending-resistant element has a width of from 30 to 60 mm and is attached to the fabric by filling a urethane resin in at least 85% of the space of the fabric at the selvage portion thereof. The guide protrusion is attached by fusion-bonding to a bending-resistant portion to which the bending-resistant element has been attached.

### RELATED APPLICATION

This application claims priority from Japanese Patent Application No. 2005-353401 filed Dec. 7, 2005, the contents of which are incorporated herein by reference in their entirety.

### BACKGROUND OF THE INVENTION

1. Field of the Invention

The present invention relates to a belt to be used particularly in a washing step for removing ink particles and ash content from an aqueous solution of paper materials regenerated as a result of de-inking or de-ashing of wastepaper such as newspaper or a in a step of dehydrating the aqueous solution or thickening pulp raw materials; and a manufacturing method of the belt.

2. Description of the Related Art

A thickening machine is employed in a washing step for removing ink particles and ash content from an aqueous solution of paper materials regenerated by de-inking or de-ashing of wastepaper such as newspaper and magazine or in a step of dewatering and thickening pulp raw materials.

There are some kinds of thickening machines but any of them has a mechanism of reducing the water content of paper materials or pulp raw materials. One of them is a thickening machine equipped with two rolls and an endless belt which is made of a fabric and suspended on these rolls. In this machine, pulp materials are supplied between these rolls and belt and by the nip pressure between the inner roll and belt and centrifugal force caused by high speed rotation, ink particles, ash content, fibers too minute to form paper, and excess water are removed continuously from an aqueous solution of paper materials.

In paper making, materials are supplied onto a belt uniformly in small portions. In thickening of paper materials such as waste paper, on the other hand, a solid content in the unevenly dispersed form is released onto the belt. A large load is therefore applied unevenly to the fabric and the endless belt may be deformed and torn when the rotating belt travels obliquely. In order to prevent such a phenomenon, an attempt has been made to equip a fabric, at an end portion thereof in a width direction, with a guide protrusion and also with a bending-resistant element for preventing breaking of the fabric on the boundary surface between the guide protrusion and fabric.

As such a technology, a fabric having a guide sawn thereon is disclosed in Japanese Patent Laid-Open No. H02-14090 (1990). In this structure, some looseness between the guide and fabric, which has appeared as a result of fixing by sawing, can lessen the breaking at the end portion of the fabric, but on the contrary, low guiding performance allows meandering of the belt, dropping of the guide protrusion from the fabric or tear of the belt at the boundary surface between the bending-resistant element and fabric. In Japanese Patent Laid-Open No. H4-361682 (1992), disclosed is a fabric having a guide fusion-bonded thereto. This method is superior to the above-described method which adopts sewing for fixing, because guide performance is high and guide protrusion hardly drops off from the fabric. In either belt disclosed by Japanese Patent Laid-Open No. H2-14090 (1990) and Japanese Patent Laid-Open No. H4-361682 (1992), however, constituent yarns of the fabric are worn away inside the fabric, which causes separation of the fabric into upper and lower layers, or the fabric is torn away at the boundary surface with the bending-resistant element, though depending on the structure of the fabric. In particular, the fabric ordinarily used as a dewatering and thickening belt and prepared by weaving upper and lower layers with a weft binding yarn is sometimes separated into upper and lower layers because the binding yarn is rubbed between upper and lower layers and is worn out.

In order to overcome such problems, a thickening belt using a fabric obtained by weaving three-layered wefts with a warp has been developed. A cross-sectional view taken along the warp of the fabric is illustrated in FIG. 1 of Japanese Patent Laid-Open No. H8-144185 (1996). The technology employed in this fabric is considered as a countermeasure against the separation, into upper and lower layers, of the conventional two-layer fabric using a weft binding yarn, which occurs by the internal wear of the weft binding yarn. Since the wefts are woven with a warp-direction yarn on which a tension is applied, a warp serving as a binding yarn is rarely broken by the rubbing inside of the fabric. When the warp is broken partially by the abrasion wear on both sides of the fabric, however, an endless fabric traveling under tension may sometimes be broken at that part.

As described above, thickening belts so far developed do not satisfy necessary performances such as guiding performance, fixing strength of a guide protrusion to a fabric, resistance against breaking of the fabric, and resistance against breaking at the boundary surface.

### SUMMARY OF THE INVENTION

An object of the present invention is to overcome various problems which cannot be solved by the conventional thickening belts, for example, separation of a fabric into upper and lower layers, breaking of an endless fabric owing to the breaking of a warp, dropping-off of a guide protrusion, insufficient guide performance and cutting of the fabric at the boundary between the guide-attached portion and the fabric.

The present invention relates to a dewatering and thickening belt that comprises an endless fabric made of a fabric woven by a synthetic resin filament, a bending-resistant element disposed at least one selvage in a width direction of the endless fabric, and a guide protrusion. The endless fabric is a two-layer fabric obtained by binding an upper side layer made of upper surface side warps and upper surface side wefts and a lower surface side layer made of lower surface side warps and lower surface side wefts with warp binding yarns for weaving the upper and lower layers, while the warp binding yarns pass over the upper surface side wefts and below the lower surface side wefts. The bending-resistant element is made of an ether- or ester-based polyurethane resin, has a width of from 30 to 60 mm, and is attached to the fabric by filling a urethane resin in at least 85% of the space of the fabric at the selvage of the fabric. The guide protrusion is made of an ether- or ester-based polyurethane resin and is attached by fusion-bonding to a bending-resistant portion to which the bending-resistant element has been attached.

The two-layer fabric may be composed of warp pairs, in which each pair has an upper surface side warp and a lower surface side warp arranged vertically; upper warp binding yarn pairs, each pair having an upper warp binding yarn which has been substituted for the upper surface side warp of the warp pair, and a lower surface side warp; and/or lower warp binding yarn pairs, each pair having a lower warp binding yarn which has been substituted for the lower surface side warp of the warp pair, and an upper surface side warp.

The two-layer fabric may be composed of warp pairs each having an upper surface side warp and a lower surface side warp arranged vertically; and upper/lower warp binding yarn pairs each having an upper warp binding yarn and a lower warp binding yarn which have been substituted for the upper surface side warp and the lower surface side warp of the warp pair, respectively.

The bending-resistant element may be attached to the fabric so that the outer end portion of the element is located at the end portion of the fabric or outside thereof.

The bending-resistant element of a dewatering and thickening belt is a urethane sheet having a width of from 30 to 60 mm and thickness of from 1 to 3 mm and by the thermocompression bonding of the urethane sheet, the sheet is filled inside of the fabric and thereby attached thereto.

The bending-resistant element may be non-linear at the inner end portion thereof. The bending-resistance element may be corrugated at the inner end portion thereof. A resin may be applied to the boundary between the inner end portion of the bending-resistant element and the fabric body.

The dehydrating or thickening belt as described above may be made by fusion-bonding the bending-resistant element and guide protrusion to at least one selvage of an endless fabric made of a fabric woven by a synthetic resin filament.

The present invention makes it possible to provide a dewatering and thickening belt excellent in various performances which the thickening belt must have, for example, guide performance, breaking strength, bonding strength of a guide protrusion, layer-separation resistance of a fabric, breaking strength of a belt, that is, strength against the breaking of warps of the fabric.

### BRIEF DESCRIPTION OF THE DRAWINGS

FIG. 1 is a side view of a thickening machine using a dewatering and thickening belt.

FIG. 2 is a detail view illustrating the selvage of the belt of the present invention suspended on a roll.

FIGS. 3A and 3B are cross-sectional views of a warp binding yarn pair and a warp pair constituting the fabric used for the belt of the present invention respectively.

FIG. 4 is a cross-sectional view of the belt of the present invention suspended on the roll.

FIG. 5 is a photograph of the inner surface of the upper side layer of the belt obtained in Conventional Example after the internal wear test.

FIG. 6 is a photograph of the inner surface of the upper side layer of the belt of the present invention after the internal wear test.

FIG. 7 is cross-sectional views of an upper warp binding yarn pair constituting the fabric used for the belt of the present invention respectively.

FIG. 8 is cross-sectional views of a lower warp binding yarn pair constituting the fabric used for the belt of the present invention respectively.

FIG. 9 is cross-sectional views of a warp pair and a warp binding yarn constituting the fabric used for the belt of the present invention respectively.

### DETAILED DESCRIPTION OF THE INVENTION

The present invention relates to a thickening belt to be used in washing treatment for removing ink particles and ash content from an aqueous solution of paper materials regenerated as a result of de-inking or de-ashing of wastepaper such as newspaper and magazine or a in a thickening machine for dehydrating and thickening the pulp raw materials. The belt has a bending-resistant element and a guide protrusion fixed to at least one selvage, in a width direction, of an endless fabric obtained by making a fabric woven by a synthetic resin filament endless in a known manner.

The term “traveling direction” as used herein means a direction of a belt or fabric and “width direction” means a direction perpendicular to the traveling direction. The traveling direction corresponds to the circumferential direction of the endless fabric. In the description of the fabric, all the terms “end portion in the width direction”, “end portion of the fabric”, “selvage portion”, and “selvage” refer to the same portion. In the description of the bending-resistant element, terms “inner end portion” and “outer end portion” mean a portion of the bending-resistant element near an area to be dehydrated and thickened and a portion of the element near the selvage of the fabric, respectively. The end portions of the guide protrusion are expressed similarly as “outer end portion” and “inner end portion”. With regards to the two sides of the belt, the inside of the endless fabric is called “roll contact surface”. The upper and lower portions of the fabric are called “upper side layer” and “lower side layer”, respectively, but either may be used as the roll contact surface.

The fabric is a two-layer fabric obtained by binding an upper side layer made of upper surface side warps and upper surface side wefts and a lower side layer made of lower surface side warps and lower surface side wefts with warp binding yarns which weave the upper and lower layers, passing over the upper surface side wefts and below the lower surface side wefts. When materials are supplied to the upper side layer, water and the like are discharged from the lower side layer. It is the common practice to decrease the diameter of yarns constituting the material-supplied surface and thereby form a dense structure in order to retain fibers thereon, and increase the diameter of yarns constituting the water-exist-side layer and thereby form a rough structure in order to attain smooth water drainage and maintain fiber rigidity. A structure in which two layers, that is, upper and lower layers are woven by a binding yarn is preferred because these layers are independent each other to permit selection of fabric designs respectively. Such freedom of the design cannot be attained by belts made of the conventional fabrics such as fabrics with three weft layers and one warp layer, fabrics with two weft layers and one warp layer and single layer fabrics.

In the conventional fabric having three weft layers and one warp layer, all the warps are binding yarns for weaving upper and lower wefts so that when one warp or two, three or more warps near the warp are worn out by abrasion with a roll or scraper or by friction inside of the fabric, nearby warps which cannot put up with the weight of the materials or tension are broken one by one and the fabric gets holes or finally the fabric itself is broken. When as well as warp binding yarns, upper surface side warps and lower surface side warps are respectively independent as in the present invention, on the other hand, even if one warp binding yarn is broken, other warps different in design or function take charge of the tension in the warp direction, which prevents spreading of further breaking of yarns in the warp direction. Use of a wide and highly-rigid yarn as lower surface side warps improves the breaking prevention effects further.

Warps constituting the two-layer fabric is composed of warp pairs having an upper surface side warp and/or a lower surface side warp arranged vertically and a binding yarn. No particular limitation is imposed on the design, arrangement ratio or arrangement position of the binding yarn. Preferred examples include fabrics having warp pairs, at least one of which is an upper warp binding yarn pair composed of an upper warp binding yarn and a lower surface side warp and obtained by substituting the upper warp binding yarn for the upper surface side warp of the warp pair; fabrics having warp pairs, at least one of which is a lower warp binding yarn pair composed of a lower warp binding yarn and an upper surface side warp and obtained by substituting the lower warp binding yarn for the lower surface side warp of the warp pair; and the fabrics having warp pairs, at least one of which is an upper/lower warp binding yarn pair composed of an upper warp binding yarn and a lower warp binding yarn and obtained by substituting the upper warp binding yarn and lower warp binding yarn for the upper surface side warp and lower surface side warp of the warp pair, respectively.

In this specification, the upper warp binding yarn is not a particular yarn but is substituted, as a binding yarn, for an upper surface side warp which must be disposed originally. The upper warp binding yarn has a design in which it passes over at least one upper surface side weft and below at least one lower surface side weft. Similarly, the lower warp binding yarn is not a particular yarn but is substituted, as a binding yarn, for a lower surface side warp which must be disposed originally. The lower warp binding yarn has a design in which it passes over at least one upper surface side weft and below at least one lower surface side weft. They are described in order to elucidate which yarn is substituted by a warp binding yarn to bind upper and lower layers or which yarn is a partner of the warp binding yarn.

As the arrangement of binding yarns, it is preferred to allow two warps constituting a binding yarn pair function as a part of an upper surface side warp and a lower surface side warp, respectively. Described specifically, in the upper/lower warp binding yarn pair, an upper warp binding yarn is woven with an upper surface side weft to form a portion of an upper side layer, below which a lower warp binding yarn is woven with a lower surface side weft to form a portion of a lower side layer. On the contrary, a lower warp binding yarn is woven with a upper surface side weft to form a portion of the upper side layer, below which an upper warp binding yarn is woven with an lower surface side weft to form a portion of the lower side layer. When binding yarns are arranged as described above, they form portions of the upper side layer and the lower side layer similar to other upper surface side warps and lower surface side warps so that the resulting fabric has a uniform surface without partial wear, partial sticking of fibers or uneven dewatering. These binding yarns are not always woven with wefts. For example, when an upper warp binding yarn is woven with an upper surface side weft, a lower warp binding yarn of the pair may partially have a design in which it passes between upper surface side wefts and lower surface side wefts. In addition, use of warp binding yarns equal in diameter and design to upper surface side warps is preferred because they form a uniform dewatering surface without local wear. An object of the present invention resides not in formation of a pulp sheet having a uniform surface but in formation of a dewatering and thickening belt so that severe evenness as is necessary for paper making fabrics is not required and therefore, no particular limitation is imposed on the diameter and design of the yarn.

Yarns to be used in the present invention may be selected depending on the using purpose. Examples of them include, in addition to monofilaments, multifilaments, spun yarns, finished yarns subjected to crimping or bulking such as so-called textured yarn, bulky yarn and stretch yarn, and yarns obtained by intertwining them. As the cross-section of the yarn, not only circular form but also square form, short form such as stellar form, or elliptical or hollow form can be used. The material of the yarn can be selected freely and not only ordinarily employed yarns such as polyester and polyamide, but also chemical fibers, synthetic fibers and natural fibers can be used. Of course, yarns obtained using copolymers or mixing the above-described material with a substance selected depending on the intended purpose may be used.

Polyester monofilaments having rigidity and excellent size stability are preferred as warps of the thickening belt. Wefts, on the other hand, may be obtained by combined weaving, for example, by alternately arranging polyester monofilaments and polyamide monofilaments.

In the above description, upper surface side warps and lower surface side warps are arranged vertically at the same ratio. The arrangement ratio of upper surface side warps may be made greater than that of lower surface side warps and vice versa. With regard to warp binding yarns, arrangement of at least one warp binding yarn in the complete design of the fabric is necessary.

The fabric thus woven is made endless in a known manner.

A bending-resistant element is attached to at least one selvage of the fabric thus obtained. The bending-resistant element is attached in order to prevent the breaking of the fabric which will otherwise occur at the boundary between the fabric and a guide protrusion attached thereto or at the contact portion with the end of a roll at which the breaking occur most frequently. The guide protrusion is disposed in order to stabilize the traveling of the belt so that it must have enough rigidity. The guide protrusion attached to the selvage portion of the fabric has higher rigidity than the fabric so that a stress concentrates on the boundary between the guide protrusion and the portion of the fabric to which it has been attached or a portion of the fabric brought into contact with the end portion of the roll and the fabric is sometimes broken at this portion. The bending-resistant element is attached to prevent this.

The bending-resistant element is made of a polyurethane resin. Especially, ether- or ester-based polyurethane resins are preferred as its material, because they have high strength, have good wear resistance, can be bound well with the fabric, and have flexibility high enough to be smoothly folded back at the inner roll. The bending-resistant element may be seamless along the traveling direction of the fabric, though depending on the rigidity, amount or hardness of the resin. A bending-resistant element cut into pieces of a proper length may be arranged discontinuously in the traveling direction to facilitate smooth folding of the belt.

The bending-resistant element is fixed to the fabric by melting the polyurethane resin and filling it in at least 85% of the space of the fabric. When the space filled with it is less than 85%, the element produces only small bending resistant effects and fixing strength is insufficient. As the bending-resistant element, a sheet or a thermosetting resin may be used. The sheet itself may be fusion-bonded or a resin for fusion bonding the sheet may be filled in the fabric and sheet may be fixed via the resin. The sheet having a thickness of from about 1 mm to 3 mm can be used. After the sheet is overlapped with the end portion of the fabric, thermocompression bonding is performed to allow the resin to penetrate into the fabric, moreover, to penetrate even to the vicinity of the surface on the reverse side of the fabric. After the bending-resistant element is attached, application of a resin to the boundary between the inner end portion of the bending-resistant element and the fabric itself is preferred because by it, the bending-resistant element can be fixed to the fabric firmly and peeling can be avoided. No limitation is imposed on the kind and application amount of the resin and it may be applied between the boundary surface and the slightly inside thereof. Alternatively, the selvage of the fabric may be sandwiched between the overlapped and folded halves of the sheet, followed by fusion bonding.

The bending-resistant element has a width of from 30 to 60 mm. When it has a width less than 30 mm, a load is imposed on the inner end portion of the bending-resistant element and the fabric is broken from this portion similar to a fabric equipped with only a guide. The element having a width exceeding 60 mm, on the other hand, is not preferred from the standpoint of efficient operation, because the bending-resistant element is attached after water drainage holes for dewatering are filled so that an effective surface area decreases when the element is too wide.

The bending-resistant element may be attached to a position in the vicinity of the selvage portion of the fabric. It may be attached to both of the end portions of the fabric or one of them. With regard to the outer end portion of the bending-resistant element, the element is attached preferably to the position a little outside of the end portion of the fabric. The end portion of the fabric is not exposed from the outside, which eliminates the fear of fraying of yarns. It is needless to say that the outer end portion of the bending-resistant element precisely overlaps with the end portion of the fabric. The bending-resistant element is attached so that its inner end portion overlaps slightly with the roll. When the inner end portion of the bending-resistant element is outside of the end portion of the roll, stress concentration occurs at this portion and the fabric is broken at the boundary. The inner end portion may be linear, but it is preferably corrugated or serrated to disperse the stress and avoid breaking of the fabric.

As described above, the element may be attached while adjusting the position, width and form.

The bending-resistant element may be attached to either side of the fabric. When the element is attached to the roll contact surface, it can protect the fabric from breaking which will otherwise occur owing to the wear caused by the abrasion with the end portion of the roll. Even if it is attached to the reverse side, filling of a polyurethane resin excellent in rigidity and wear resistance in at least 85% of the inner space of the fabric disturbs bending and prevents wear sufficiently.

The guide protrusion is also made of an ether- or ester-based polyurethane resin. It is fixed by fusion bonding to a bending resistant portion to which the bending-resistant element has been attached. Such a polyurethane resin is employed because it has high strength, has good wear resistance, can be bound well with the fabric, and has high flexibility to facilitate folding-back at the inner roll. The bending-resistant element is fixed by filling a polyurethane resin inside of the fabric, but the guide protrusion may be fixed by fusion bonding with the polyurethane resin thus filled. For example, the guide protrusion and the resin can be integrated by overlapping a sheet made of a polyurethane resin, which will be a bending-resistant element, with the end portion of the fabric, thermocompression bonding them to allow the resin to penetrate into the fabric sufficiently even into the vicinity of the reverse side of the fabric, thermocompression bonding the guide protrusion made of another polyurethane resin to the fabric from the surface opposite to the sheet-fixed surface of the fabric, and fusion bonding these polyurethane resins into one inside of the fabric. Use of the same polyurethane resin for the guide protrusion and for filling in the fabric is preferred because it increases fixing strength. It is also possible to attach, not via the resin, the guide protrusion by fusion bonding to the side on which the bending-resistant element is disposed. The position of the guide protrusion is not limited insofar as the inner end portion of the guide protrusion is disposed outside of the inner end portion of the bending-resistant element. The outer end portion of the guide protrusion may be aligned with the outer end portion of the bending-resistant element or may be disposed inside thereof.

The shape of the guide protrusion is not limited insofar as it can serve as a guide for preventing the meandering of the belt. It may have a rectangular, circular or triangle cross-section, but a protrusion having a trapezoidal cross-section is suited because a large area can be provided for fusion bonding. The guide protrusion may be in the form of one rod or in the form of some rods, but the protrusion in the form of some separated rods enables smooth folding-back at the inner roll.

### EXAMPLES

The present invention will hereinafter be described specifically based on accompanying drawings.

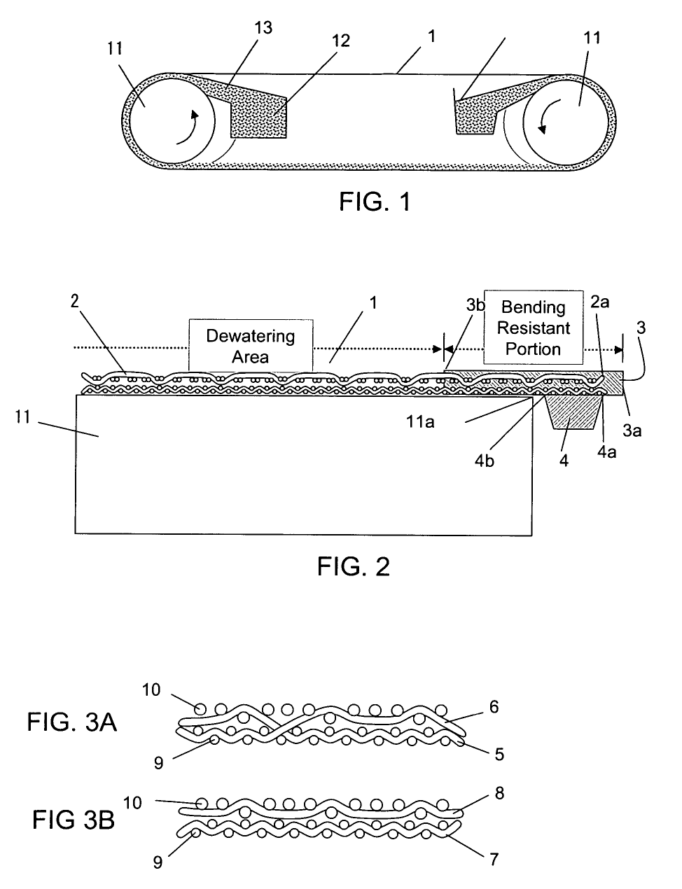

FIG. 1 is a side view of a thickening machine using the dewatering and thickening belt 1 of the present invention. The dewatering belt 1 is suspended over two rolls 11 under tension. An aqueous solution 12 of paper materials is supplied between the rolls 11 and belt 1 from a material supply port 13. By making use of a nip pressure between the inner rolls and belt and centrifugal force caused by high speed rotation, ink particles, ash content, fibers too minute to form paper, and excess water are removed from the aqueous solution of paper materials continuously. In paper making, materials are supplied uniformly onto a belt in small portions. In thickening of paper materials such as waste paper, on the other hand, a solid content in the unevenly dispersed form is released on the belt. Uneven imposition of load on the fabric and oblique traveling of the endless belt which is rotating may sometimes lead to deformation and tear of the belt.

As illustrated in FIG. 2, a guide protrusion 4 is disposed in the vicinity of the end portion of a dewatering area of a fabric 2 and, in order to prevent breaking of the fabric at the boundary surface between the guide protrusion 4 and fabric 1, a bending-resistant element 3 is disposed (refer to FIG. 2). The bending-resistant element 3 and guide protrusion 4 are fusion bonded to both selvages of the fabric.

In this Example, a polyurethane resin sheet which will be the bending-resistant element is overlapped with the fabric on the rough side thereof and melted by thermocompression to allow the resin to penetrate into the fabric, even to the vicinity of the opposite surface of the fabric. A guide protrusion 4 obtained by molding of a polyurethane resin is subjected to thermocompression bonding from a side of the fabric opposite to the side to which the sheet is bonded, and these polyurethane resins are fusion bonded into one inside of the fabric.

The belt of the present invention is used for dewatering of an aqueous solution of paper materials so that the fabric used for the belt preferably has an upper layer and lower layer as illustrated in FIG. 2. It is preferred that one of the layers has a dense structure made of yarns having a small diameter so as to enable retention of the fibers thereon, while the other layer has a rough structure made of yarns having a large diameter so as to improve water drainage property and keep the rigidity of the fabric. Particularly in the present invention, the belt is made of a two-layer fabric using a warp binding yarn for preventing separation between two layers which will otherwise occur by the internal wear of a binding yarn.

FIGS. 3A and 3B are cross-sectional views illustrating a warp binding yarn pair 5, 6 and a warp pair 7, 8 constituting the fabric of the present invention. The warp pair 7, 8 is illustrated in FIG. 3B. An upper surface side warp 7 and a lower surface side warp 8 illustrated in FIG. 3B are arranged vertically. A warp binding yarn pair 5, 6 for weaving upper and lower layers is illustrated in FIG. 3A. Instead of the upper surface side warp 7 constituting the warp pair 7, 8, an upper warp binding yarn 5 for weaving both upper surface side wefts 10 and lower surface side wefts 9 is arranged. Instead of the lower surface side warp 8, a lower warp binding yarn 6 for weaving both upper surface side wefts 10 and lower surface side wefts 9 is arranged. In the warp binding yarn pair 5, 6, these two yarns cooperatively function as an upper surface side warp on the upper side surface and function as a lower surface side warp on the lower side surface. Instead of the warp pair, at least one warp binding yarn pair is disposed in the complete design of a repeating unit of the fabric.

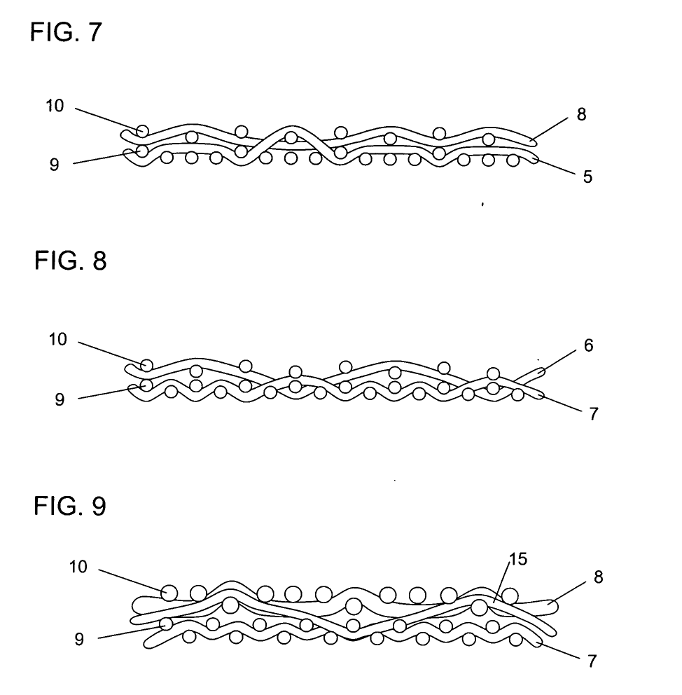

FIGS. 7, 8 and 9 illustrate cross-sectional views of examples of other fabrics in which this invention is employed. FIG. 7 is a cross-sectional view illustrating a pair of an upper surface side warp binding yarn 5 and lower surface side warp 8. All of the pairs of warps may use the structure as shown in FIG. 7. Alternatively, the warp pairs illustrated both in FIGS. 7 and 3B may be combined and arranged in a two-layer fabric.

FIG. 8 is a cross-sectional view illustrating a pair of a lower surface side warp binding yarn 6 and upper surface side warp 7. All of the pairs of warps may use the structure as shown in FIG. 8. Alternatively, the warp pairs illustrated both in FIGS. 8 and 3A/3B may be combined and arranged in a two-layer fabric.

FIG. 9 is a cross-sectional view illustrating a pair of an upper surface side warp 7 and a lower surface side warp 8, whereto a warp binding yarn 15 is included. All of the pairs of warps may use the structure as shown in FIG. 9. The binding yarn 15 simply combines the upper and lower fabrics and does not constitute the surface structure of the fabric. There is no drawback in connection with surface uniformity and other properties using this embodiment of the fabric, as far as this embodiment is used for dehydrating the aqueous solution or concentrating pulp raw material.

As in the present invention, when an upper surface side warp and a lower surface side warp exist independently in addition to a warp binding yarn, even if the warp binding yarn is broken by the internal wear or abrasion on both sides of the fabric, an upper surface side warp or lower surface side warp different in design or function undertakes the tension in the warp direction and stops further breaking of yarns in the warp direction. In particular, use of a yarn, which is wider and more rigid than an upper surface side warp, as a lower surface side warp contributes to improvement in the anti-breaking effects.

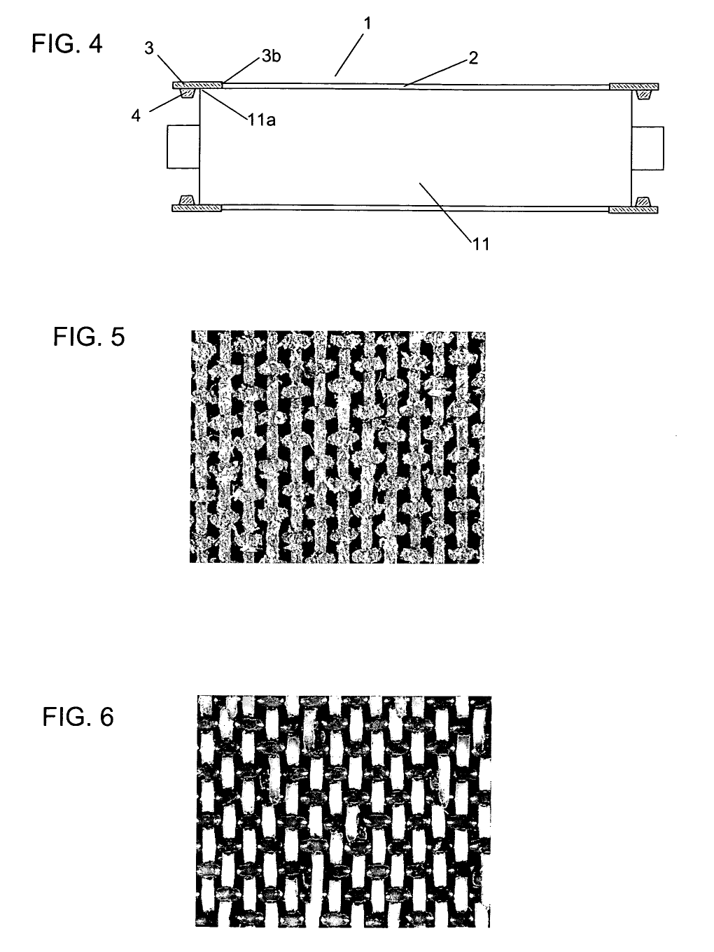

As illustrated in FIG. 4, the bending-resistant element 3 and guide protrusion 4 are fusion-bonded to the both selvages of the fabric. A polyurethane resin sheet is fixed to the fabric by melting the sheet and then filling the melted sheet in at least 85% of the space of the fabric. When the percentage is less than 85%, flex-resistant effects are small and the fixing strength is insufficient. The sheet is overlapped with the end portion of the fabric. By thermocompression bonding, the resin is penetrated into the fabric sufficiently, even into the vicinity of the surface on the reverse side of the fabric. A protrusion obtained by molding a polyurethane resin is attached by thermocompression bonding from the side opposite to the sheet attached side and these polyurethane resins are integrated by fusion bonding inside of the fabric. As illustrated in FIG. 2, the bending-resistant element is attached so that the outer end portion 3a thereof is located a little outside of the end portion 4a of the fabric in order to prevent fray of yarns and the inner end portion 3b of the bending-resistant element is located so as to slightly overlap with the roll 11. When the inner end portion 3b of the bending-resistant element is located outside of the roll end portion 11a, stress concentration occurs on the boundary between them, leading to breaking of the fabric thereat.

Internal wear test was performed using a dewatering and thickening belt made of the warp-binding type two-layer fabric of the present invention as illustrated in FIGS. 2, 3A and 3B and a dewatering and thickening belt made of a conventional weft-binding type two-layer fabric. The test of them was conducted under similar conditions except for the structure of the fabric. As the thickening machine, a machine having a mechanism substantially similar to that of FIG. 1 was employed. An aqueous solution of paper materials such as waste paper was supplied between inner rolls and belt and it was dehydrated or thickened by pressing and centrifugal dewatering. After completion of the test, a portion of the fabric was cut into a proper size. The binding yarn of the fabric was cut between the upper and lower layers to separate them and the internal wear of the fabric thus obtained was observed. FIG. 5 is a photograph of the inner surface of the upper side layer of the conventional belt, while FIG. 6 is a photograph of the surface of the inner surface of the upper side layer of the belt of the invention.

From FIG. 5, it has been understood that in the belt of the conventional example, the loosening of a binding yarn causes friction inside of the fabric and it become rough. Under such a state, not only the binding yarn but also warp or weft may be broken soon by abrasion. In short, they are almost close to their wear limit. Fluffing yarns disturb the passage of fibers so that they have an adverse effect on the dewatering property.

It has been found that wear hardly occurs in the belt of the present invention, because without loosening of a binding yarn, no friction occurs among warps and wefts on both layers. The fabric of the present invention using a warp binding yarn has far less internal wear compared with the conventional fabric so that the belt made of the fabric of the present invention is excellent.

In addition, an internal wear test was performed under severe conditions, but neither falling off of the guide protrusion and the bending-resistant element nor breaking of the selvage occurred.

The present invention provides a belt for removing ink particles and ash content from an aqueous solution of paper materials regenerated as a result of de-inking or de-ashing of waste paper such as newspaper, dehydrating the aqueous solution or concentrating pulp raw materials. Since it does not cause separation of the fabric, breaking of the fabric, and dropping-off of the guide protrusion, it can be suitably used particularly in a washing machine or thickening machine for dehydrating or thickening of waste paper.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. A dewatering and thickening belt comprising an endless fabric made of a fabric woven by a synthetic resin filament, a bending-resistant element disposed at a selvage of the endless fabric and a guide protrusion, wherein:
the fabric is a two-layer fabric obtained by binding an upper side layer and a lower side layer, wherein warp binding yarns weave the upper and lower layers while passing over upper surface side wefts and under lower surface side wefts, wherein at least either ones of upper side warps or lower side warps are disposed in either the upper side layer or the lower side layer;
the bending-resistant element is made of an ether- or ester-based polyurethane resin, having a width of from 30 to 60 mm, and being attached to the fabric by filling a urethane resin in at least 85% of the space of the fabric at the selvage of the fabric; and
the guide protrusion is made of an ether- or ester-based polyurethane resin and is attached by fusion-bonding to a bending-resistant portion of the endless fabric to which the bending-resistant element is attached.

2. A dewatering and thickening belt according to claim 1, wherein the two-layer fabric is composed of upper warp binding yarn pairs, each pair having an upper warp binding yarn and a lower surface side warp; and/or lower warp binding yarn pairs, each pair having a lower warp binding yarn and an upper surface side warp.

3. A dewatering and thickening belt according to claim 1, wherein the two-layer fabric is composed of warp pairs each having an upper surface side warp and a lower surface side warp arranged vertically and upper/lower warp binding yarn pairs each having an upper warp binding yarn, and a lower warp binding yarn.

4. A dewatering and thickening belt according to claim 1, wherein the bending-resistant element is attached to the fabric so that the outer end portion of the element is located at the end portion of the fabric or outside thereof.

5. A dewatering and thickening belt according to claim 1, wherein the bending-resistant element is a urethane sheet having a width of from 30 to 60 mm and thickness of from 1 to 3 mm and the urethane sheet is filled inside of the fabric and thereby attached thereto by thermocompression bonding.

6. A dewatering and thickening belt according to claim 1, wherein the bending-resistant element is not linear at the inner end portion thereof.

7. A dehydrating or thickening belt according to claim 6, wherein the bending-resistance element is corrugated at the inner end portion thereof.

8. A dehydrating or thickening belt according to claim 1, wherein a resin is applied to a boundary between the inner end portion of the bending-resistant element and the fabric body.

9. A manufacturing process of a dehydrating or thickening belt as described in claim 1, which comprise fusion-bonding the bending-resistant element and guide protrusion to at least one selvage of an endless fabric made of a fabric woven by a synthetic resin filament.
